(19) United States
(12) Patent Application Publication
(10) Pub. No.: US 2011/0141088 A1
(43) Pub. Date: Jun. 16, 2011

(54) LIQUID CRYSTAL DISPLAY

(75) Inventor: Byung-Kil JEON, Asan-si (KR)

(73) Assignee: SAMSUNG ELECTRONICS CO., LTD., Suwon-si (KR)

(21) Appl. No.: 12/817,515

(22) Filed: Jun. 17, 2010

(30) Foreign Application Priority Data
Dec. 11, 2009 (KR) 10-2009-0122991

(51) Int. Cl. G09G 5/00

(52) U.S. Cl. 345/211; 345/87

(57) ABSTRACT

A liquid crystal display includes a pixel, an image signal modification unit and a data driver. The image signal modification unit includes a still image detection unit which receives a previous image signal and a current image signal of two consecutive frames and determines whether the current image signal is for a still image, a first modification unit which receives the current image signal and outputs a first current modified image signal or the current image signal, and a second modification unit which receives the current image signal and outputs a second current modified image signal or the current image signal. The data driver changes the second current modified image signal or the current image signal into a data voltage and supplies the data voltage to the pixel. The first modification unit outputs the current image signal when the current image signal is determined to be for the still image.

This application claims priority to Korean Patent Application No. 10-2009-0122991, filed on Dec. 11, 2009, and all the benefits accruing therefrom under 35 U.S.C. §119, the content of which in its entirety is herein incorporated by reference.

### BACKGROUND OF THE INVENTION

(1) Field of the Invention

The present invention provides a liquid crystal display (“LCD”) and, more particularly, an LCD having substantially improved display quality.

(2) Description of the Related Art

In general, a liquid crystal display (“LCD”) includes two display panels having pixel electrodes and a common electrode formed respectively thereon, and a liquid crystal layer having dielectric anisotropy interposed between the two display panels. The pixel electrodes are typically arranged in a matrix pattern, and are connected to switching elements, such as thin film transistors (“TFTs”). A data voltage is sequentially applied to rows of the pixel electrodes. The common electrode is disposed on a surface of one of the two display panels, and is supplied with a common voltage. The pixel electrode, the common electrode, and the liquid crystal layer interposed therebetween form a liquid crystal capacitor. The liquid crystal capacitor and the corresponding switching element connected thereto form a unit pixel.

In the liquid crystal display, when a voltage is applied to the pixel electrodes, an electric field is generated in the liquid crystal layer. An intensity of the electric field is adjusted to control a transmittance of light that passes through the liquid crystal layer to display a desired image on the LCD. However, when the electric field is applied to the liquid crystal layer in a given direction for an extended period of time, deterioration of the liquid crystal layer occurs. Accordingly, in efforts to prevent this deterioration, a polarity of the data voltage, with respect to the common voltage, is inverted every frame, every column and/or for every pixel.

In addition to overcoming the abovementioned deficiencies, there is a significant need to improve display quality of a motion picture, as well as of a still image, in the LCD, which is widely used in devices such as computers and televisions, for example.

### BRIEF SUMMARY OF THE INVENTION

A liquid crystal display (“LCD”) according to an exemplary embodiment of the present invention includes a pixel, an image signal modification unit and a data driver. The image signal modification unit includes a still image detection unit which receives a previous image signal and a current image signal of two consecutive frames and determines whether the current image signal is for a still image, a first modification unit which receives the current image signal and outputs a first current modified image signal or the current image signal, and a second modification unit which receives the current image signal and outputs a second current modified image signal or the current image signal. The data driver changes the second current modified image signal or the current image signal outputted from the second modification unit into a data voltage and supplies the data voltage to the pixel. The first modification unit outputs the current image signal when the current image signal is determined to be for the still image.

The second modification unit may output the current image signal when the current image signal is determined to be for the still image.

The image signal modification unit may include a first encoding unit that encodes the current image signal, and a first decoding unit that decodes the encoded current image signal into a first current decoded image signal. The still image detection unit may determine whether the first current decoded image signal is for the still image.

The image signal modification unit may further include a second encoding unit that encodes the first current modified image signal or the current image signal, a frame memory, and a second decoding unit that generates a first previous decoded image signal or a second previous decoded image signal based on the previous image signal and decoding data stored in the frame memory.

The frame memory may be an embedded dynamic random access memory (“eDRAM”).

The first previous decoded image signal or the second previous decoded image signal may be inputted to the still image detection unit.

The first previous decoded image signal or the second previous decoded image signal may be inputted to the first modification unit and the second modification unit.

The second modification unit may execute, e.g., perform, overshoot driving or undershoot driving when the first current decoded image signal is determined to not be for the still image.

The first current modified image signal may have a value corresponding to a voltage charged to the pixel in a current frame.

A difference between the previous image signal and the first current modified image signal may be less than a difference between the previous image signal and the current image signal.

The image signal modification unit may further include: a third modification unit that outputs the current modified image signal or the current image signal; a second encoding unit that encodes a third current modified image signal or the current image signal; a frame memory; and a second decoding unit that generates the first previous decoded image signal or a third previous decoded image signal based on the previous image signal and decoding data stored in the frame memory.

The third modification unit may output the current image signal when the current image signal is determined to be for a still image.

The third modification unit may receive a mode signal from the second decoding unit and output the third current modified image signal based on the mode signal when the current image signal is determined to not be for the still image.

The third current modified image signal may be determined according to a shrink ratio based on the magnitude of an error rate of the second decoding unit.

The current image signal and the first current modified image signal may be inputted to the third modification unit.

When the first current decoded image signal is determined to not be for the still image, the third current modified image signal is equal to the current image signal plus a shrink ratio multiplied by a difference between the first current modified image signal and the current image signal, such that the following equation is satisfied: Third current modified image signal=current image signal+(first current modified image signal−current image signal)*shrink ratio (%).

A liquid crystal display according to another exemplary embodiment of the present invention includes: a pixel; an image signal modification unit comprising a first modification unit that receives a previous image signal and a current image signal of two consecutive frames and outputs a first current modified image signal, a second modification unit that receives the current image signal and outputs a second current modified image signal or the current image signal, a third modification unit that outputs a third current modified image signal or the current image signal, an encoding unit that encodes third current modified image signal, a frame memory, and a decoding unit that decodes data stored in the frame memory into a previous decoded image signal based on the previous image signal; and a data driver that changes the second current modified image signal or the current image signal outputted from the second modification unit into a data voltage and supplies the data voltage to the pixel. The third modification unit receives a mode signal from the second decoding unit, and outputs the third current modified image signal based on the mode signal.

The third current modified image signal may be determined according to a shrink ratio based on the magnitude of an error rate of the second decoding unit.

The current image signal and the first current modified image signal may be inputted to the third modification unit.

The third current modified image signal may be equal to the current image signal plus a shrink ratio multiplied by a difference between the first current modified image signal and the current image signal, such that the following equation is satisfied: Third current modified image signal=current image signal+(first current modified image signal−current image signal)*shrink ratio (%).

The frame memory may be an eDRAM.

The image signal modification unit may further include a still image detection unit that determines whether the current image signal is for a still image.

The previous decoded image signal may be inputted to the still image detection unit.

The second modification unit may output the current image signal when the current image signal is determined to be for the still image.

The second modification unit may output the third current modified image signal when the current image signal is determined to not be for the still image.

The third previous decoded image signal may be inputted to the first modification unit and the second modification unit.

The second modification unit may perform, e.g., execute, overshoot driving or undershoot driving.

The first current modified image signal may have a value corresponding to a voltage charged to the pixel in a current frame.

A difference between the previous image signal and the first current modified image signal may be less than a difference between the previous image signal and the current image signal.

Thus, in exemplary embodiments of the present invention, the display quality of a motion picture and a still image is substantially improved.

### BRIEF DESCRIPTION OF THE DRAWINGS

The above and other aspects and features of the present invention will become more apparent by describing in further detail exemplary embodiments thereof with reference to the accompanying drawings, in which:

FIG. 1 is a block diagram of an exemplary embodiment of a liquid crystal display (“LCD”) according to the present invention;

FIG. 2 is a block diagram of an exemplary embodiment of an image signal modification unit of a liquid crystal display according to the present invention;

FIG. 3 is a graph of gray level versus frames illustrating an exemplary embodiment of a changing of a gray according to frames according to the present invention;

FIG. 4 is an exemplary embodiment of a lookup table of a first modification unit according to the present invention;

FIG. 5 is an exemplary embodiment of a lookup table of a second modification unit according to the present invention;

FIG. 6 is a block diagram of another exemplary embodiment of an image signal modification unit of a liquid crystal display according to the present invention; and

FIG. 7 is a block diagram of still another exemplary embodiment of an image signal modification unit of a liquid crystal display according to the present invention.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the present invention will be described in further detail with reference to the accompanying drawings.

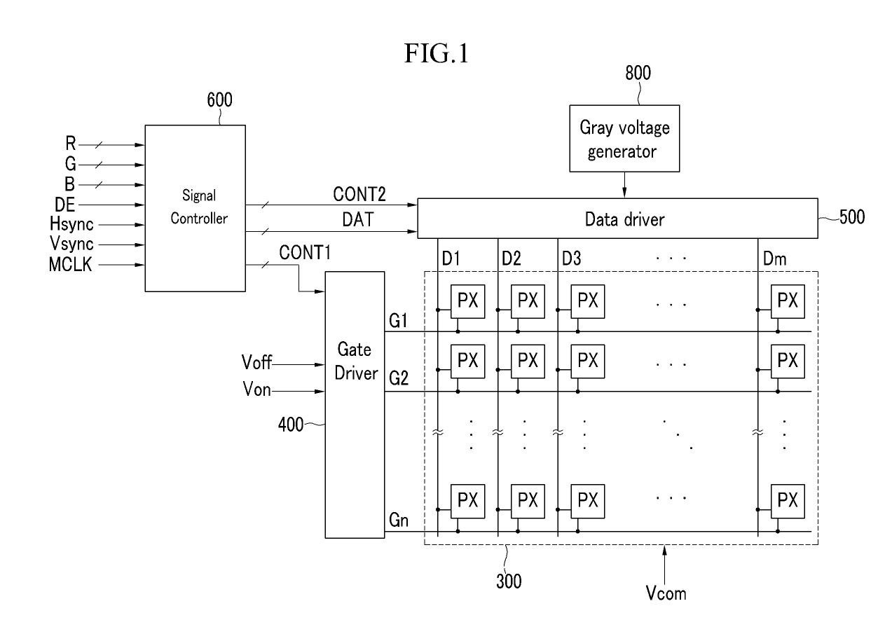

A liquid crystal display (“LCD”) according to an exemplary embodiment of the present invention will now be described in further detail with reference to FIG. 1.

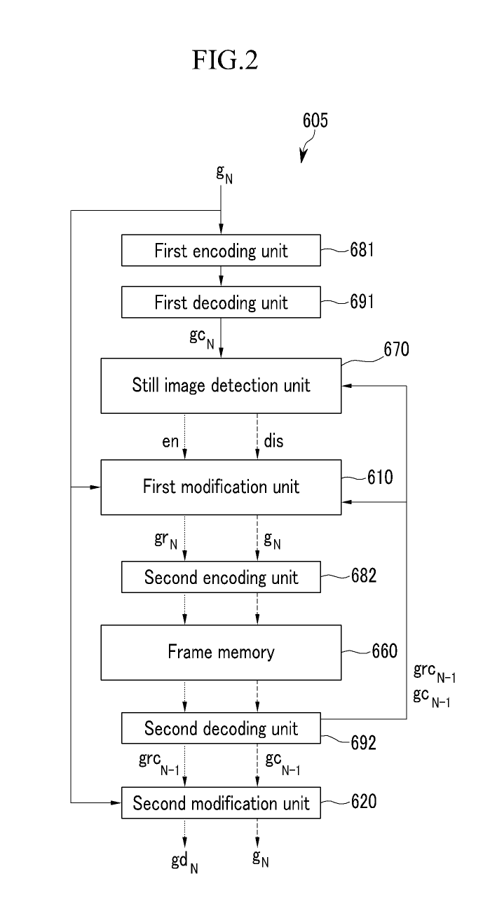

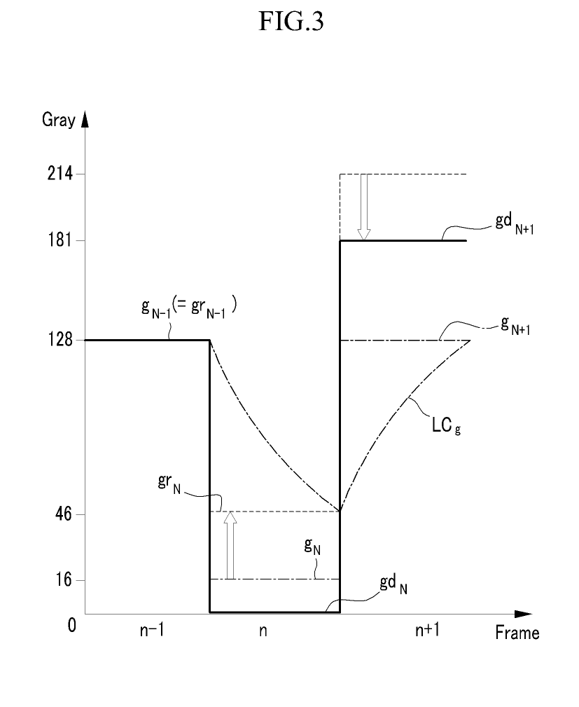

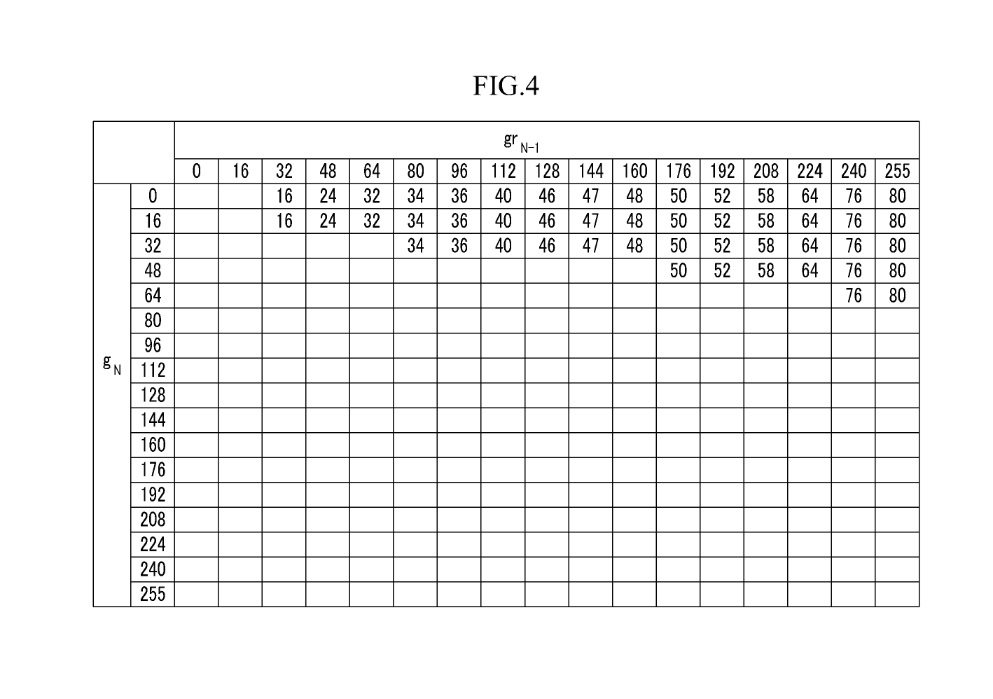

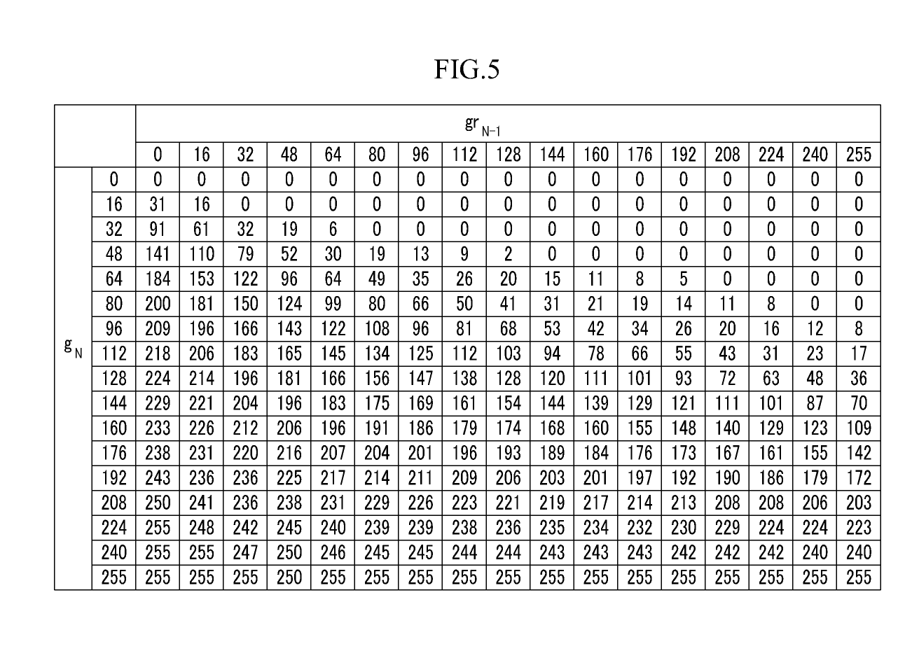

FIG. 1 is a block diagram of an exemplary embodiment of a liquid crystal display according to the present invention, FIG. 2 is a block diagram of an exemplary embodiment of an image signal modification unit of a liquid crystal display according to the present invention, FIG. 3 is a graph of gray level over consecutive frames illustrating an exemplary embodiment of a changing of gray levels according to the present invention, FIG. 4 is an exemplary embodiment of a lookup table of a first modification unit according to the present invention, and FIG. 5 is an exemplary embodiment of a lookup table of a second modification unit according to the present invention.

As shown in FIG. 1, a liquid crystal display according to an exemplary embodiment of the present invention includes a liquid crystal panel assembly 300, a gate driver 400 and a data driver 500 connected to the liquid crystal panel assembly 300, a gray voltage generator 800 connected to the data driver 500, and a signal controller 600 for controlling one or more of the abovementioned components.

The liquid crystal panel assembly 300 includes a plurality of signal lines G₁-Gₙ and D₁-Dₘ, and a plurality of pixels PX connected thereto and arranged substantially in a matrix pattern on the liquid crystal panel assembly 300.

The plurality of signal lines G₁-Gₙ and D₁-Dₘ includes gate lines G₁-Gₙ for transmitting gate signals (also referred to as “scanning signals”), and data lines D₁-Dₘ for transmitting data signals. The gate lines G₁-Gₙ extend substantially along a first, row direction (as viewed in FIG. 1) and are aligned substantially parallel to each other, while the data lines D₁-Dₘ extend substantially along an opposite second, column direction and are aligned substantially parallel to each other.

Each pixel PX of the plurality of pixels PX, such as a pixel PX connected to an i-th (i=1, 2, . . . , n) gate line Gᵢ and a j-th (j=1, 2, . . . , m) data line Dⱼ for example, includes a switching element (not shown) connected to the signal lines Gᵢ and Dⱼ and a liquid crystal capacitor (not shown) and a storage capacitor (not shown) connected thereto. Each pixel PX may include a plurality of subpixels. In an additional exemplary embodiment, the storage capacitor may be omitted. In an exemplary embodiment, the switching element is a three terminal element, such as a thin film transistor (“TFT”), which includes a control terminal connected to the gate line Gᵢ, an input terminal connected to the data line Dⱼ, and an output terminal connected to the liquid crystal capacitor and the storage capacitor. The connection relationship of the pixel PX, the signal line Gᵢ and Dⱼ, and the switching element is not limited to the foregoing description, and may be modified, such as a configuration in which two pixels PX share one gate line Gn and/or a in which two pixels PX share one data line Dm, although additional exemplary embodiments are not limited thereto.

The liquid crystal capacitor has a pixel electrode (not shown) and a common electrode (not shown) as terminals thereof, and a liquid crystal layer (not shown) disposed between the pixel and common electrodes is a dielectric material thereof.

The storage capacitor, which serves as an auxiliary capacitance to the liquid crystal capacitor, is formed with a separate signal line (not shown) in addition to the gate line and the data line and the pixel electrode overlapping it with an insulator interposed therebetween, and a predetermined voltage, such as a common voltage Vcom, for example, is applied to the separate signal line. However, in another exemplary embodiment, the storage capacitor may be formed by a pixel electrode and a previous gate line arranged to overlap each other with an insulator disposed therebetween.

To display a color image, each pixel PX represents one color of the primary colors (e.g., using spatial division) or, alternatively, each pixel PX may sequentially represent the primary colors in turn (e.g., using temporal division), such that a spatial (or temporal) sum of the primary colors is recognized by a viewer as a desired color. The primary colors include red, green and blue.

The signal controller 600 is supplied with input image signals R, G and B and input control signals, for controlling the display thereof, such as a vertical synchronization signal Vsync, a horizontal synchronization signal Hsync, a main clock signal MCLK and a data enable signal DE from an external graphics controller (not shown). The signal controller 600 processes the image signals R, G and B according to operating conditions of the liquid crystal panel assembly 300 and based on the input image signals R, G and B and the input control signals, and generates a gate control signal CONT1 and a data control signal CONT2. The signal controller 600 supplies the gate control signal CONT1 to the gate driver 400, and supplies the data control signal CONT2 and a processed image signal DAT to the data driver 500. In an exemplary embodiment, the processing of the image signals R, G and B includes an operation of rearranging the image data R, G and B according to an arrangement of the pixels PX of the liquid crystal panel assembly 300, as will be described in greater detail below with reference to FIGS. 2-7.

Still referring to FIG. 1, the gate control signal CONT1 includes a scanning start signal (not shown) for instructing the display device to start scanning, and at least one clock signal (not shown) for controlling an output cycle of a gate-on voltage Von, which is provided to the gate driver 400 (along with a gate-off voltage Voff). The gate control signal CONT1 may further include an output enable signal (not shown) for limiting a duration of the gate-on voltage Von.

The data control signal CONT2 includes a horizontal synchronization start signal (not shown) for informing a start of transmission of image data with respect to one group of the pixels PX, and a load signal (not shown) for instructing application of a corresponding data voltage to the data lines D1-Dm and a data clock signal (not shown). The data control signal CONT2 may further include an inversion signal (not shown) for inverting a polarity of the data voltage, with respect to a common voltage Vcom (hereinafter, “the polarity of the data voltage with respect to the common voltage” will simply be referred to as “the polarity of the data voltage.”)

The data driver 500 sequentially receives groups of image data DAT for a row of the pixels PX in response to the data control signal CONT2 transmitted from the signal controller 600, and selects a gray voltage corresponding to each image data DAT from among the gray voltages from the gray voltage generator 800. Thus, the data driver 500 converts the image data DAT into the corresponding data voltages, and supplies the data voltages to corresponding data lines D1 to Dm.

The gate driver 400 sequentially applies the gate-on voltage Von to each of the gate lines G1-Gn in response to the scanning control signal CONT1 from the signal controller 600, thereby turning on the associated switching element connected to each of the gate lines G1-Gn. The data voltages applied to the data lines D1-Dm are then supplied to the corresponding pixels PX through the turned-on switching elements.

A difference between the data voltages applied to the pixels PX and the common voltage Vcom is expressed as a charged voltage, e.g., a pixel voltage. Thus, an arrangement of liquid crystal molecules in a liquid crystal layer (not shown) in the liquid crystal panel 300 is changed depending on a magnitude of the pixel voltage, thereby changing a polarization of light passing through the liquid crystal layer. The change of polarization causes a change of light transmittance through a polarizer attached to the display panel.

Each of the drivers 400, 500, 600 and 800 may be directly mounted on the liquid crystal panel assembly 300 in the form of at least one integrated circuit (“IC”) chip, or may be mounted on a flexible printed circuit film (not shown) and then mounted on the liquid crystal panel assembly 300 in the form of a tape carrier package (“TCP”), or may be mounted on a separate printed circuit board (not shown). Alternatively, the drivers 400, 500, 600 and 800 may be integrated with the liquid crystal panel assembly 300 together with, for example, the signal lines G1-Gn and D1-Dm and the thin film transistor switching elements. The drivers 400, 500, 600 and 800 may be integrated into a single chip. In this case, at least one of the drivers 400, 500, 600 and 800, or at least one circuit forming the drivers 400, 500, 600 and 800, may be arranged outside the single chip.

Hereinafter, an image signal modification unit 605 of a liquid crystal display according to an exemplary embodiment of the present invention will be described in further detail with reference to FIG. 2.

The image signal modification unit 605 modifies an image signal, e.g., the input image signals R, g and B, to significantly improve the display quality of both a motion picture and a still image displayed on the liquid crystal display, and may be included in the signal controller 600 or, alternatively, may be disposed separate from the signal controller 600. As shown in FIG. 2, the image signal modification unit 605 includes first and second modification units 610 and 620, respectively, a frame memory 660, a still image detection unit 670, first and second encoding units 681 and 682, respectively, and first and second decoding units 691 and 692, respectively. In an exemplary embodiment, an image signal (hereinafter referred to as a “current image signal”) g_{N} of one frame, e.g., a current frame, for a pixel PX may be modified based on an image signal (hereinafter referred to as a “previous image signal) g_{N-1} of a temporally previous frame, which may be directly adjacent and previous to the current frame, for the pixel PX. An image signal (hereinafter referred to as a “next image signal”) g_{N+1} of a temporally subsequent frame, which may be directly adjacent and subsequent to the current frame, of the pixel PX may be modified based on the current image signal g_{N} and the previous image signal g_{N-1}. The temporal relationship between the previous, current and next frames, e.g., (n−1)-th, n-th and (n+1)-th frames, respectively, is best shown in FIG. 3, which is discussed in further detail below.

Still referring to FIG. 2, the first and second modification units 610 and 620 may modify the image signal g_{N} of the current frame, e.g., the n-th frame, by a predetermined calculation based on the image signal g_{N} of the current frame and the image signal g_{N-1} of the directly previous frame, e.g., the (n−1)th frame, stored in the frame memory 660, and transmit the modified image signal to the data driver 500. In an exemplary embodiment, the image signal g_{N-1} of the directly previous frame stored in the frame memory 660 may be the original image signal transmitted from the external graphics controller, e.g., the input image signal R, G or B, or may be the image signal modified from the calculation processing in the first and second modification units 610 and 620. The first and second encoding units 681 and 682 encode the image signal using a predetermined encoding algorithm, and the first and second decoding units 691 and 692 decode the encoded image signal using a predetermined decoding algorithm. In an exemplary embodiment, the encoded image signal has a smaller size than a size of the original image signal, such that the frame memory 660 has a small capacity and a decreased memory bandwidth may be used, thereby substantially reducing cost of the display apparatus. In an exemplary embodiment, the frame memory 660 may be an external memory, and may be an embedded dynamic random access memory (“eDRAM”). The eDRAIVI is a DRAM embedded in a chip including a logic circuit, such that performance of the chip may be improved by a fast connection, such as to other components.

In an exemplary embodiment, the signals modified by the first modification unit 610 are referred to as a first previous modified image signal gr_{N-1}, a first current modified image signal gr_{N} and a first next modified image signal gr_{N+1}. The signals modified by the second modification unit 620 are referred to as a second previous modified image signal gd_{N-1}, a second current modified image signal gd_{N} and a second next modified image signal gd_{N+1}. When the previous image signal g_{N-1}, the current image signal g_{N}, and the next image signal g_{N+1} are decoded after encoding, the decoded signal is referred to as a first previous decoded image signal gc_{N-1}, a first current decoded image signal gc_{N} and a first decoded image signal gc_{N+1}. When the modified signal is decoded by the third modification unit 630 after encoding, the decoded signal is referred to as a second previous decoded image signal grc_{N-1}, a second current decoded image signal grc_{N} and a second decoded image signal grc_{N+1}.

The first encoding unit 681 reads the current image signal g_{N}, and encodes the current image signal g_{N} using an encoding algorithm. The first decoding unit 691 decodes the encoded image signal using a decoding algorithm, and outputs the current decoded image signal gc_{N}. In an exemplary embodiment, the encoding algorithm and the decoding algorithm include various algorithms, such as a Huffman method, a run length method, a Lempel-Ziv method and a discrete cosine transform (“DCT”), although additional exemplary embodiments are not limited thereto. The still image detection unit 670 reads the current decoded image signal gc_{N} and the previous decoded image signals gc_{N-1} and grc_{N-1}, and compares the abovementioned signals to determine whether they are for a still image. Specifically, for example, a difference between the current decoded image signal gc_{N} and the previous decoded image signals gc_{N-1} and grc_{N-1} is calculated, and when the absolute value of the difference thereof is less than a previous predetermined value, it is determined that the abovementioned signals are for a still image, and a disable signal dis is outputted, while if it is more than the predetermined value, it is determined that the abovementioned signals are not for a still image, and an enable signal en is outputted. In an exemplary embodiment, the predetermined value may be determined by experiment, for example.

The first previous decoded image signal gc_{N-1} corresponds to a signal that is determined to be for the still image. That is, referring to the previous frame, when the still image detection unit 670 determines the previous image signal g_{N-1} as being for the still image, the still image detection unit 670 outputs the disable signal dis, and the first modification unit 610 outputs the previous image signal g_{N-1} as it is without modification. Accordingly, the previous image signal g_{N-1} without modification is stored in the frame memory 660, and the still image detection unit 670 reads the first previous decoded image signal gc_{N-1} from the frame memory 660 through the second decoding unit 692. Accordingly, the still image detection unit 670 may determine whether the current image signal g_{N} is for the still image based on the first previous decoded image signal gc_{N-1} without modification stored in the frame memory 660 such that further accurate determination of the still image is possible compared with a still image detection based upon the modified image signal stored in the frame memory 660.

In an exemplary embodiment, when the function of the still image detection unit 670 is executed before that of the first modification unit 610, and the current (n-th) frame is determined to be for the still image, the first modification unit 610 outputs the current image signal g_{N} as it is, e.g., without modification, based on the disable signal dis of the still image detection unit 670. Accordingly, a divergence of the first current modified image signal gr_{N}, generated when a data encoding or decoding error exists and the still image detection unit 670 is not included in a display apparatus, is substantially reduced and/or is effectively prevented, and noise generated during screen switching is also significantly reduced, thereby substantially improving the display quality of the still image in a display apparatus according to the present invention. As used herein, the divergence of the first current modified image signal gr_{N} refers to outputting an image signal that the first modification unit 610 does not converge to the still image by a data encoding or decoding error, even though still images are inputted in consecutive frames.

Thus, the second previous decoded image signal grc_{N-1} corresponds to a signal that is determined to be for the still image. Accordingly, when the still image detection unit 670 does determines that the previous image signal g_{N-1} is not for the still image, the still image detection unit 670 outputs the enable signal en, and the first modification unit 610 modifies the previous image signal g_{N-1} such that the first previous modified image signal gr_{N-1} is outputted. As a result, the first previous modified image signal gr_{N-1} is stored in the frame memory 660, and the still image detection unit 670 reads the second previous decoded image signal grc_{N-1} from the frame memory 660 through the second decoding unit 692.

Still referring to FIG. 2, the first modification unit 610 reads the current image signal g_{N} and the previous decoded image signals gc_{N-1} and grc_{N-1}, and executes the calculation according to the signals received from the still image detection unit 670. Specifically, when receiving the enable signal en from the still image detection unit 670, the current image signal g_{N} is modified based on the previous decoded image signals gc_{N-1} and grc_{N-1} such that the first current modified image signal gr_{N} is outputted. When receiving the disenable signal dis from the still image detection unit 670, the current image signal g_{N} is outputted as it is, e.g., without modification.

The second encoding unit 682 reads the first current modified image signal gr_{N} or the current image signal g_{N} and encodes them using an encoding algorithm, and the encoded image signal is stored in the frame memory 660 for modification of the next image signal g_{N+1}.

The second decoding unit 692 reads the encoded image signal from the frame memory 660 in the previous frame, and decodes it using a decoding algorithm. Specifically, when the still image detection unit 670 outputs the enable signal en in the previous frame, the second encoding unit 682 encodes the first previous modified image signal gr_{N-1}, thereby storing it in the frame memory 660, and the second decoding unit 692 outputs the second previous decoded image signal grc_{N-1}. The second previous decoded image signal grc_{N-1} is transmitted to the still image detection unit 670, the first modification unit 610 and the second modification unit 620. When the still image detection unit 670 outputs the disable signal dis in the previous frame, the second encoding unit 682 encodes the previous image signal g_{N-1} thereby storing it in the frame memory 660, and the second decoding unit 692 outputs the first previous decoded image signal gc_{N-1}. The first previous decoded image signal gc_{N-1} is transmitted to the still image detection unit 670, the first modification unit 610 and the second modification unit 620.

On the other hand, the second current decoded image signal grc_{N} or the first current decoded image signal gc_{N-1} are outputted from the frame memory 660 in the next frame, e.g., in the (n+1)-th frame, and are inputted to the first modification unit 610, the second modification unit 620 and still image detection unit 670.

The second modification unit 620 reads the current image signal g_{N} and the previous decoded image signals gc_{N-1} and grc_{N-1}, and executes the calculation according to the signals received from the still image detection unit 670. More particularly, when receiving the enable signal en from the still image detection unit 670, the current image signal g_{N} is modified based on the previous decoded image signals gc_{N-1} and grc_{N-1} to output the second current modified image signal gd_{N}. When receiving the disable signal dis from the still image detection unit 670, the current image signal g_{N} is outputted as it is, e.g., without modification.

An operation of the first modification unit 610 and the second modification unit 620 will now be described in further detail with reference to FIGS. 3-5.

In an exemplary embodiment, the second modification unit 620 operates using dynamic capacitance compensation (“DCC”). Specifically, DCC is based on the fact that the higher the voltage that is applied to th terminals of the liquid crystal capacitor is, the more rapid the charging speed becomes. The data voltage applied to the pixel PX (essentially being the difference between the data voltage and the common voltage, which, for purposes of description is assumed to be, but is not limited to, 0 volts) is increased to be greater than the target voltage, so that the time for the voltage charged in the liquid crystal capacitor to reach the target voltage is reduced.

The first modification unit 610 complements overshoot driving and/or undershoot driving by the second modification unit 620. More specifically, for example, when the image of the previous, e.g., (n−1)-th, frame is brighter than the image of the current (n-th) frame in a liquid crystal display that utilizes a normally black mode, e.g., the pixel voltage corresponding to the previous image signal g_{N-1} is increased to be more than the pixel voltage corresponding to the current image signal g_{N}, the pixel voltage corresponding to the current image signal g_{N} is not applied to the pixel electrode as it is, but a larger pixel voltage is instead applied, which is referred to as overshoot driving. Similarly, when the pixel voltage corresponding to the previous image signal g_{N-1} is decreased less than the pixel voltage corresponding to the current image signal g_{N}, the pixel voltage corresponding to the current image signal g_{N} is not applied to the pixel electrode as it is, but a smaller pixel voltage is instead applied, which is referred to as undershoot driving. The overshoot driving and the undershoot driving compensates for a slow rotation speed of the liquid crystal molecules.

However, when the difference between the previous image signal g_{N-1} and the current image signal g_{N} becomes greater, and/or the time of 1 frame becomes shorter, the actual pixel voltage of the current frame may not be obtained at the pixel voltage corresponding to the current image signal g_{N}, even if the second modification unit 620 implements the overshoot driving and/or the undershoot driving. In this case, the first modification unit 610 replaces the current image signal g_{N} with the first current modified image signal gr_{N}, and the first current modified image signal gr_{N} has a value corresponding to the actual pixel voltage of the current frame. Thus, when the difference between the previous image signal g_{N-1} and the first current modified image signal gr_{N} is less than the difference between the previous image signal g_{N-1} and the current image signal g_{N}. As a result, the frame memory 660 stores the replaced first current modified image signal gr_{N}, and the next image signal g_{N-1} executes the overshoot driving and/or the undershoot driving based on the first current modified image signal gr_{N} (not based on the current image signal g_{N}) by the second modification unit 620. Accordingly, the first modification unit 610 substantially improves the display quality in a display device according to the present invention and, more particularly, in a display device having a relatively high frame rate, such as 120 hertz (Hz) or 240 Hz, for example.

FIG. 4 shows an example of the first current modified image signal gr_{N} for several example pairs of the first previous modified image signal gr_{N-1} and the current image signal g_{N} when a number of grays is 256, e.g., when grays range from 0 through 255. More particularly, FIG. 4 is a lookup table for undershoot driving, and it will be noted that a lookup table for overshoot driving may be provided as either an independent lookup table, or as a combined lookup table, e.g., integral to the lookup table shown in FIG. 4. In another exemplary embodiment, a lookup for undershoot driving may not be provided, and only a lookup table for overshoot driving may be provided. FIG. 5, for example, shows an exemplary embodiment of the second current modified image signal gd_{N} for several pairs of the first previous modified image signal gr_{N-1} and the current image signal g_{N} when the number of grays is 256, e.g., the image signal is represented by 8 bits, and has one value from 0 to 255.

In an exemplary embodiment, a size of the lookup table is sufficient to store the modified image signals gr_{N} and gd_{N} for all pairs of the first previous modified image signal gr_{N-1} and the current image signal g_{N}, and for example, the modified image signals gr_{N} and gd_{N} for some pairs of the first previous modified image signal gr_{N-1} and the current image signal g_{N} (as shown in FIGS. 4 and 5) is stored as a reference modified image signal, and pairs of the remaining first previous modified image signal gr_{N-1} and the remaining current image signal g_{N} are calculated by using an interpolation method thereby obtaining the modified image signals gr_{N} and gd_{N}.

Referring now to FIG. 3, and assuming, for purposes of illustration, that the previous image signal g_{N-1}, the current image signal g_{N} and the next image signal g_{N+1} are sequentially 128, 16 and 128, respectively, and the previous image signal g_{N-1} and the first previous modified image signal gr_{N-1} are equal to each other, it can be seen that the second modification unit 620 modifies the current image signal g_{N} of 16 based on the first previous modified image signal gr_{N-1} of 128 to thereby output the second current modified image signal gd_{N} such that the second current modified image signal gd_{N} is 0 (according to the lookup table of FIG. 5). Thus, the second modification unit 620 executes the undershoot driving. Moreover, in the current (n-th) frame, the gray of the liquid crystal is actually 46, and does not arrive at the value 16 of the current image signal g_{N}, despite the undershoot driving of the second modification unit 620. In this case, the first modification unit 610 replaces the current image signal g_{N} (with a value of 16) with the first current modified image signal gr_{N} based on the first previous modified image signal gr_{N-1} of 128, and according to the lookup table of FIG. 5, the first current modified image signal gr_{N} is 46, which is the same as the actual gray LCg of the liquid crystal in the current (n-th) frame. The second modification unit 620 outputs the second next modified image signal gd_{N+1} by modifying the next image signal g_{N+1} (with a value of 128) based on the first current modified image signal gr_{N} (value of 46), such that the second next modified image signal gdN_{N+1} is 181, based on the value in the lookup table of FIG. 5.

If the modification by the first modification unit 610 were not executed, the second modification unit 620 would be based on the current image signal g_{N} of 16, which is not replaced, such that the next image signal g_{N+1} of 128 would be modified to 214, and, as a result, the liquid crystal gray of the next frame would exceed 128.

On the other hand, if the first previous modified image signal gr_{N-1} inputted to the first modification unit 610 is 128 and the current image signal g_{N} is 96, the first modification unit 610 outputs the current image signal g_{N} of 96 according to the lookup table of FIG. 4 without modification. The second modification unit 620 modifies the next image signal g_{N+1} by the lookup table of FIG. 5 based on the current image signal g_{N} of 96.

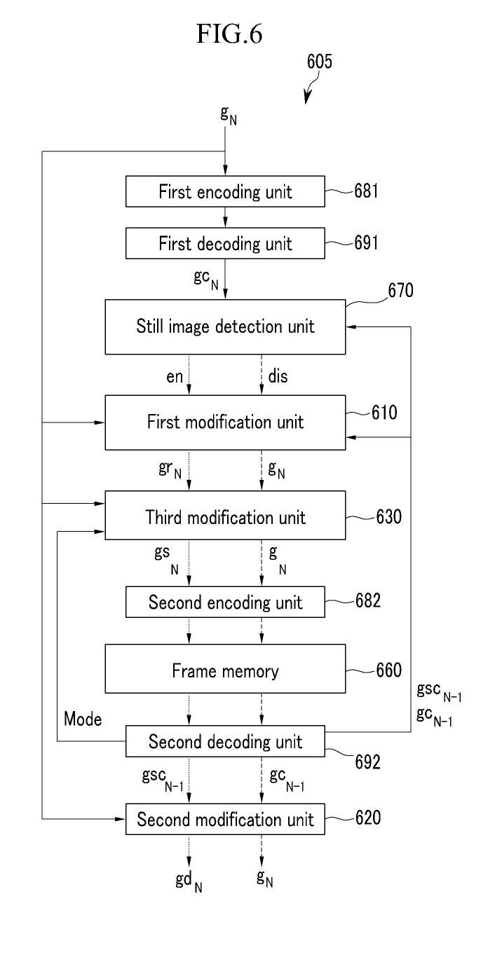

An image signal modification unit of a liquid crystal display according to another exemplary embodiment of the present invention will now be described in further detail with reference to FIG. 6. The same or like components in FIG. 6, described in greater detail above and shown in FIGS. 1-5, have been labeled with the same reference characters in FIG. 6 and, therefore, any repetitive detailed description thereof will hereinafter be omitted or simplified.

FIG. 6 is block diagram of another exemplary embodiment of an image signal modification unit 605 of a liquid crystal display according to the present invention.

In an exemplary embodiment, the signals modified by the third modification unit 630 is referred to as a third previous modified image signal gs_{N-1}, a third current modified image signal gs_{N} and a third next modified image signal gs_{N+1}. When the signals modified by the third modification unit 630 is decoded after encoding, the decoded signal is referred to as a third previous decoded image signal gsc_{N-1} a third current decoded image signal gsc_{N}, and a third decoded image signal gsc_{N+1}.

The image signal modification unit 605 according to an additional exemplary embodiment includes a third modification unit 630.

The third modification unit 630 receives a mode signal (“Mode”) from the second decoding unit 692, executes a modification based on the mode signal, the current image signal g_{N} and the first current modified image signal gr_{N}, and outputs the third current modified image signal gs_{N}. When the enable signal en is outputted by the still image detection unit 670, the third modification unit 630 normally executes the modification calculation, thereby outputting the third current modified image signal gs_{N}. When the disable signal en is outputted by the still image detection unit 670, the third modification unit 630 may output the current image signal g_{N} as it is, not based on the first current modified image signal gr_{N}.

In an exemplary embodiment, for example, the modification calculation of the third modification unit 630 may be expressed by Equation 1, below.

gs_{N}=g_{N}+(gr_{N}−g_{N})*shrink ratio [Equation 1]

In Equation 1, the shrink ratio, which is expressed in percent (%), may have a value of 0% to 100%, depending on the mode signal. For example, in a predetermined encoding or decoding algorithm, the magnitude of the encoding or decoding error ratio is determined according to several modes, and when a mode signal corresponding to a mode having a large error rate is inputted, the shrink ratio may be defined as a large value, while when a mode signal corresponding to a mode having a small error rate is input, the shrink ratio may be defined as a small value (relatively speaking). In an exemplary embodiment, the magnitude of the shrink ratio according to the modes may be defined according to experimental results. Specifically, for example, if the shrink ratio corresponding to the mode having the predetermined error rate increases, the probability that the first modification unit 610 outputs an image signal that is not converged to the still image decreases. In contrast, if the shrink ratio corresponding to the mode having the predetermined error rate decreases, the first modification unit 610 may further improve the display quality of a display device having a high frame rate.

Based upon the calculation of the third modification unit 630, when the still image detection unit 670 determines that the still image is not inputted, even though still images are inputted in consecutive frames, divergence of the image signal output from the first modification unit 610 by the encoding/decoding error is substantially reduced. Thus, if the difference between the current image signal g_{N} and the first current modified image signal gr_{N} decreases according to the magnitude of the error rate based upon the mode, when still images are inputted in consecutive frames, the first modification unit 610 is prevented from outputting the image signal that is not converged to the still image, or the number of frames taken until the first modification unit 610 outputs the image signal converged to the still image may be reduced. On the other hand, when still images are inputted in consecutive frames and the still image detection unit 670 determines the still images, the third modification unit 630 may output the current image signal g_{N} as it is, e.g., without modification.

When the third current modified image signal gs_{N} is outputted from the third modification unit 630, the encoded image signal is stored in the frame memory 660 by the second encoding unit 682. The encoded image signal is decoded by the second decoding unit 692, and the second decoding unit 692 outputs the third current decoded image signal gsc_{N}. The third current decoded image signal gscₙ is inputted to the first modification unit 610 and the second modification unit 620 for the modification of the next image signal g_{N+1}, and is inputted to the still image detection unit 670 to determine whether the next image signal g_{N+1} is for the still image. When the current image signal g_{N} is outputted from the third modification unit 630, the second decoding unit 692 outputs the first current decoded image signal gc_{N}. The first current decoded image signal gc_{N} is inputted to the first modification unit 610 and the second modification unit 620 for the modification of the next image signal g_{N+1}, and is inputted to the still image detection unit 670 to determine whether the next image signal g_{N+1} is for the still image.

On the other hand, the third previous decoded image signal gsc_{N-1} or the first previous decoded image signal gc_{N-1} is outputted from the frame memory in the current frame and is inputted to the first modification unit 610, the second modification unit 620 and the still image detection unit 670.

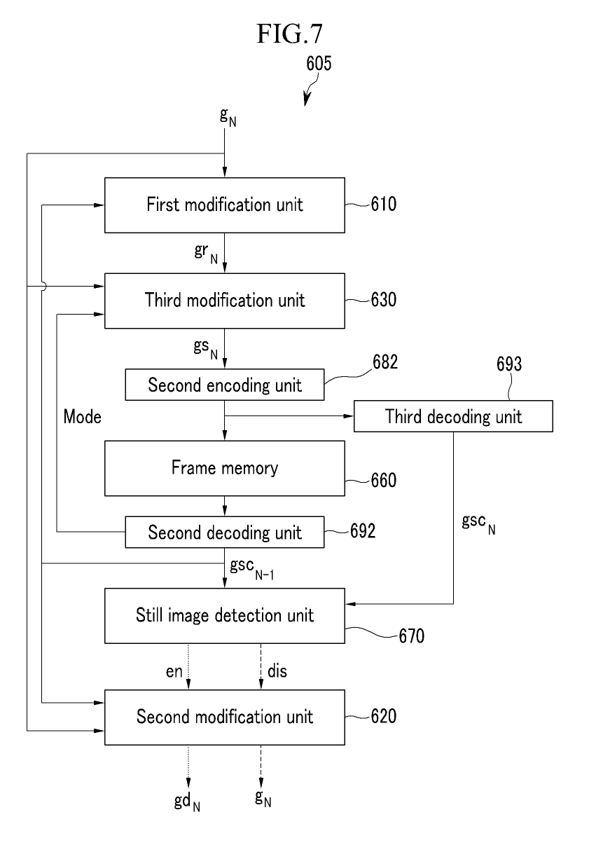

An image signal modification unit of a liquid crystal display according to still another exemplary embodiment of the present invention will now be described in further detail with reference to FIG. 7. The same or like components in FIG. 7, described in greater detail above and shown in FIGS. 1-6, have been labeled with the same reference characters in FIG. 7 and, therefore, any repetitive detailed description thereof will hereinafter be omitted or simplified.

FIG. 7 is block diagram of an exemplary embodiment of an image signal modification unit 605 of a liquid crystal display according to the present invention.

The image signal modification unit 605 includes the third modification unit 630.

However, in contrast to the third modification unit 630 in the exemplary embodiment shown in FIG. 6, the third modification unit 630 of the additional exemplary embodiment shown in FIG. 7 may not receive the enable signal en and the disable signal dis from the still image detection unit 670.

As shown in FIG. 7, the third modification unit 630 receives the mode signal (“Mode”) from the second decoding unit 692, performs a modification based on the mode signal, the current image signal g_{N} and the first current modified image signal gr_{N}, and outputs the third current modified image signal gs_{N}. In an exemplary embodiment, the modification calculation of the third modification unit 630 is in accordance with Equation 1 (above). In Equation 1, a magnitude of the shrink ratio, according to the modes, may be appropriately defined according to experimental results. Specifically, for example, if the shrink ratio corresponding to a mode having the predetermined error rate increases, the probability that the first modification unit 610 outputs the image signal that is not converged to the still image decreases. However, if the shrink ratio corresponding to the mode having the predetermined error rate decreases, the first modification unit 610 further improves the display quality of the display device having the high frame rate.

Based upon the calculation of the third modification unit 630, when the still image is inputted in continuous frames, divergence of the image signal outputted from the first modification unit 610 by the encoding or decoding error is substantially reduced regardless of whether the still image detection unit 670 determines the still image. Specifically, if the difference between the current image signal g_{N} and the first current modified image signal gr_{N} decrease according to the magnitude of the error rate according to the mode, when still images are inputted in consecutive frames, the first modification unit 610 outputting the image signal that is not converged to the still image is effectively prevented, and/or a number of frames until the first modification unit 610 outputs the image signal converged to the still image is substantially reduced.

The third current modified image signal gs_{N} is outputted by the third modification unit 630, and the encoded image signal is stored in the frame memory 660 by the second encoding unit 682. The encoded image signal is decoded by a third decoding unit 693, and the third decoding unit 693 outputs the third current decoded image signal gsc_{N}. The third current decoded image signal gsc_{N} is inputted to the still image detection unit 670.

On the other hand, the third current decoded image signal gsc_{N} is outputted from the frame memory in the next frame, and is inputted to the first modification unit 610, the second modification unit 620 and still image detection unit 670.

The still image detection unit 670 determines whether the third current decoded image signal gsc_{N} is for the still image, based on the third previous decoded image signal gsc_{N-1}. When the third current decoded image signal gsc_{N} is determined to be for the still image, the still image detection unit 670 outputs the disable signal dis. When the third current decoded image signal gsc_{N} is not for the still image, the still image detection unit 670 outputs the enable signal en.

If the second modification unit 620 receives the disable signal dis, the second modification unit 620 outputs the current image signal g_{N} as it is, e.g., not based on the third previous decoded image signal gsc_{N-1}. If the second modification unit 620 receives the enable signal dis, the second modification unit 620 modifies the current image signal g_{N} based on the third previous decoded image signal gsc_{N-1} thereby outputting the second current modified image signal gd_{N}.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A liquid crystal display comprising:
a pixel;
an image signal modification unit comprising:
a still image detection unit which receives a previous image signal and a current image signal of two consecutive frames and determines whether the current image signal is for a still image;
a first modification unit which receives the current image signal and outputs one of a first current modified image signal and the current image signal; and
a second modification unit which receives the current image signal and outputs one of a second current modified image signal and the current image signal; and
a data driver which changes one of the second current modified image signal and the current image signal outputted from the second modification unit into a data voltage and supplies the data voltage to the pixel,
wherein the first modification unit outputs the current image signal when the current image signal is determined to be for the still image.

2. The liquid crystal display of claim 1, wherein the second modification unit outputs the current image signal when the current image signal is determined to be for the still image.

3. The liquid crystal display of claim 1, wherein
the image signal modification unit further comprises:
a first encoding unit which encodes the current image signal; and
a first decoding unit which decodes the encoded current image signal into a first current decoded image signal, and
the still image detection unit determines whether the first current decoded image signal is for the still image.

4. The liquid crystal display of claim 3, wherein the image signal modification unit further comprises:
a second encoding unit which encodes one of the first current modified image signal and the current image signal;
a frame memory; and
a second decoding unit which generates one of a first previous decoded image signal and a second previous decoded image signal based on the previous image signal and decoding data stored in the frame memory.

5. The liquid crystal display of claim 4, wherein the frame memory is an embedded dynamic random access memory.

6. The liquid crystal display of claim 4, wherein one of the first previous decoded image signal and the second previous decoded image signal is inputted to the still image detection unit.

7. The liquid crystal display of claim 4, wherein one of the first previous decoded image signal and the second previous decoded image signal is inputted to the first modification unit and the second modification unit.

8. The liquid crystal display of claim 7, wherein the second modification unit performs one of overshoot driving and undershoot driving when the first current decoded image signal is determined to not be for the still image.

9. The liquid crystal display of claim 8, wherein the first current modified image signal has a value corresponding to a voltage charged to the pixel in a current frame.

10. The liquid crystal display of claim 8, wherein a difference between the previous image signal and the first current modified image signal is less than a difference between the previous image signal and the current image signal.

11. The liquid crystal display of claim 3, wherein the image signal modification unit further comprises:
a third modification unit which outputs one of the first current modified image signal and the current image signal;
a second encoding unit which encodes one of a third current modified image signal and the current image signal;
a frame memory; and
a second decoding unit which generates one of the first previous decoded image signal and a third previous decoded image signal based on the previous image signal and decoding data stored in the frame memory.

12. The liquid crystal display of claim 11, wherein the third modification unit outputs the current image signal when the current image signal is determined to be for the still image.

13. The liquid crystal display of claim 11, wherein the third modification unit receives a mode signal from the second decoding unit and outputs the third current modified image signal based on the mode signal when the current image signal is determined to not be for the still image.

14. The liquid crystal display of claim 13, wherein the third current modified image signal is determined according to a shrink ratio based on a magnitude of an error rate of the second decoding unit.

15. The liquid crystal display of claim 13, wherein the current image signal and the first current modified image signal are inputted to the third modification unit.

16. The liquid crystal display of claim 15, wherein, when the first current decoded image signal is determined to not be for the still image, the third current modified image signal is equal to the current image signal plus a shrink ratio multiplied by a difference between the first current modified image signal and the current image signal.

17. The liquid crystal display of claim 11, wherein the frame memory is an embedded dynamic random access memory.

18. A liquid crystal display comprising:
a pixel;
an image signal modification unit comprising:
a first modification unit which receives a previous image signal and a current image signal of two consecutive frames and outputs a first current modified image signal;
a second modification unit which receives the current image signal and outputs one of a second current modified image signal and the current image signal;
a third modification unit which outputs one of a third current modified image signal and the current image signal;
an encoding unit which encodes the third current modified image signal;
a frame memory; and
a decoding unit which decodes data stored in the frame memory into a previous decoded image signal based on the previous image signal; and
a data driver which changes one of the second current modified image signal and the current image signal outputted from the second modification unit into a data voltage and supplies the data voltage to the pixel,
wherein the third modification unit receives a mode signal from the second decoding unit and outputs the third current modified image signal based on the mode signal.

19. The liquid crystal display of claim 18, wherein the third current modified image signal is determined according to a shrink ratio based on a magnitude of an error rate of the second decoding unit.

20. The liquid crystal display of claim 18, wherein the current image signal and the first current modified image signal are inputted to the third modification unit.

21. The liquid crystal display of claim 20, wherein the third current modified image signal is equal to the current image signal plus a shrink ratio times a difference between the first current modified image signal and the current image signal.

22. The liquid crystal display of claim 18, wherein the frame memory is an embedded dynamic random access memory.

23. The liquid crystal display of claim 18, wherein the image signal modification unit further comprises a still image detection unit which determines whether the current image signal is for a still image.

24. The liquid crystal display of claim 23, wherein the previous decoded image signal is inputted to the still image detection unit.

25. The liquid crystal display of claim 23, wherein the second modification unit outputs the current image signal when the current image signal is determined to be for the still image.

26. The liquid crystal display of claim 23, wherein the second modification unit outputs the current modified image signal when the current image signal is determined to not be for the still image.

27. The liquid crystal display of claim 18, wherein the previous decoded image signal is inputted to the first modification unit and the second modification unit.

28. The liquid crystal display of claim 27, wherein the second modification unit performs one of overshoot driving and undershoot driving.

29. The liquid crystal display of claim 28, wherein the first current modified image signal has a value corresponding to a voltage charged to the pixel in a current frame.

30. The liquid crystal display of claim 28, wherein a difference between the previous image signal and the first current modified image signal is less than a difference between the previous image signal and the current image signal.
